(19) United States
(12) Patent Application Publication
(10) Pub. No.: US 2026/0040027 A1
(43) Pub. Date: Feb. 5, 2026

(54) COMMUNICATING INFORMATION BASED ON USER PROXIMITY TO A DEVICE

(71) Applicant: Motorola Mobility LLC, Chicago, IL (US)

(72) Inventors: Amit Kumar Agrawal, Bangalore (IN); Krishnan Raghavan, Bangalore (IN)

(73) Assignee: Motorola Mobility LLC, Chicago, IL (US)

(21) Appl. No.: 18/790,189

(22) Filed: Jul. 31, 2024

(51) Int. Cl. H04W 4/029; H04W 12/02; H04W 12/06

(52) U.S. Cl. CPC H04W 4/029; H04W 12/02; H04W 12/06

(57) ABSTRACT

A determination is made as to whether a known user is proximate to a first device. While a known user is proximate to the first device the first device can receive and display information received from one or more second devices. However, if a known user is not proximate to the first device, the first device communicates an indication to the one or more second devices to no longer communicate information to the first device. Additionally or alternatively, if a known user is not proximate to the first device, the first device does not display any information received from the one or more second devices.

### BACKGROUND

As technology has advanced our uses for computing devices have expanded. One such use is allowing two devices to communicate with one another so that one device can track the location of the other device. For example, a parent may configure their device and their child's device to allow the parent to track the location of the child's device.

### BRIEF DESCRIPTION OF THE DRAWINGS

Embodiments of communicating information based on user proximity to a device are described with reference to the following drawings. The same numbers are used throughout the drawings to reference like features and components:

FIGS. 1 and 2 illustrate example systems for communicating information based on user proximity to a device, as described herein;

FIG. 3 illustrates an example of operation of the techniques discussed herein;

FIGS. 4 and 5 illustrate example graphical user interfaces (GUIs), which support the techniques discussed herein;

FIG. 6 illustrates an example of operation of the techniques discussed herein;

FIGS. 7 and 8 illustrate example processes for implementing the techniques discussed herein in accordance with one or more embodiments;

FIG. 9 illustrates various components of an example electronic device that can implement embodiments of the techniques discussed herein.

### DETAILED DESCRIPTION

Communicating information based on user proximity to a device is discussed herein. Generally, one device (also referred to herein as a managing device) receives information from one or more secondary devices (each of which is also referred to herein as a managed device). Various information can be communicated from the one or more managed devices to the managing device, such as personally identifiable information. For example, the managing device may be used by a parent and a managed device used by the parent's child. The managed device can communicate the location of the managed device to the managing device, allowing the parent to know where his or her child is physically located. The location of a device refers to, for example, a physical or geographic location of the device.

Using the techniques discussed herein, a determination is made as to whether a known user is proximate to the managing device. While a known user is proximate to the managing device the managing device can receive and present (e.g., display) information received from one or more managed devices. However, if a known user is not proximate to the managing device, the managing device communicates an indication to the one or more managed devices to no longer communicate information to the managing device. Additionally or alternatively, if a known user is not proximate to the managing device, the managing device does not present (e.g., display) any information received from the one or more managed devices.

The techniques discussed herein improve the operation of a computing device by maintaining security of various information so that people other than a known user of the managing device are not presented with information received from the one or more managed devices. For example, in one scenario a known user of the managing device is a parent, and a managed device is used by the parent's child. The managed device transmits personally identifiable information to the managing device, such as the current location of the child, an indication that the child has arrived at school or arrived at home, and so forth. If the parent is no longer proximate to the managing device, the personally identifiable information is no longer transmitted to the managing device and/or is not displayed at the managing device. Thus, if the parent were to lose the managing device or the managing device were to be stolen, anyone in possession of the managing device would not be able to view the personally identifiable information.

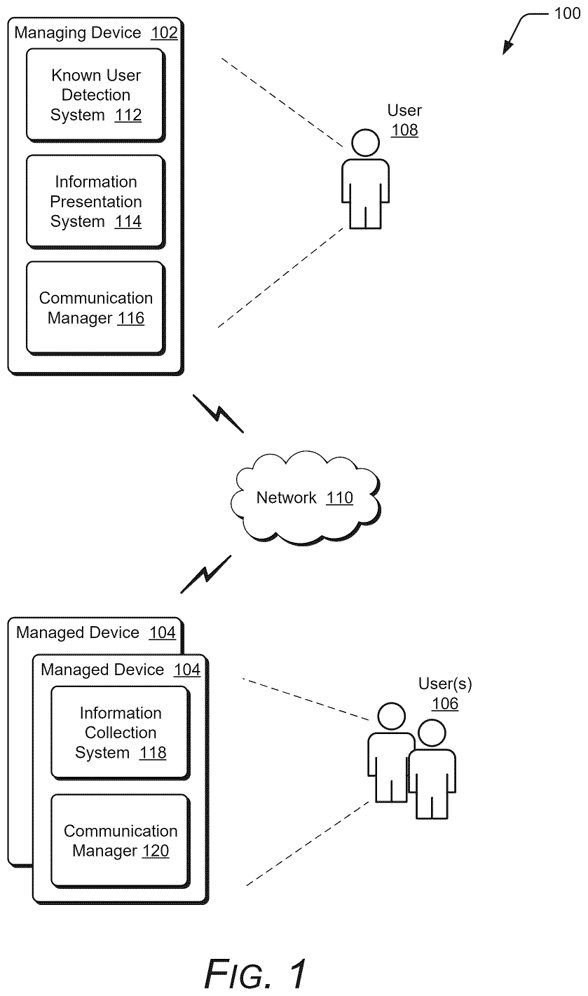

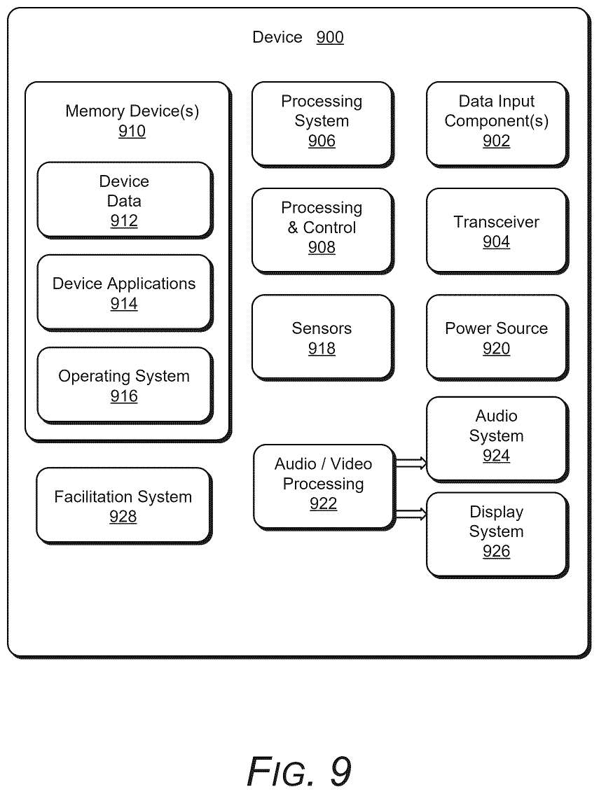

FIG. 1 illustrates an example system 100 for communicating information based on user proximity to a device, as described herein. The example system 100 includes a managing device 102, one or more managed devices 104, one or more users 106 of the one or more managed devices, and a user 108 of the managing device 102, where the managing device 102 and the one or more managed devices 104 are interconnectable via one or more networks 110. In one or more implementations the managing device 102 and the one or more managed devices 104 can be a smartphone, mobile phone, and/or any other type of wireless device or mobile device. The managing device 102 and the one or more managed devices 104 can be implemented with various components, such as a processor system and memory, as well as any number and combination of different components as further described with reference to the example device shown in FIG. 9. In one or more implementations, the managing device 102 and the one or more managed devices 104 include one or more of various radios for wireless communication with other devices (e.g., via the one or more networks 110). For example, the managing device 102 and the one or more managed devices 104 may include a Bluetooth (BT) and/or Bluetooth Low Energy (BLE) transceiver and/or a near field communication (NFC) transceiver. The managing device 102 and the one or more managed devices 104 can also include a Wi-Fi radio, a global positioning system (GPS) radio, a radio for cellular communication (e.g., a third generation (3G) network, a fourth generation (4G) network, a fifth generation (5G) network), and/or any type of device communication interfaces.

Reference is made herein to a user being proximate to a device, also referred to as being in the presence of the device or with the device. This user is a particular user, such as a known user of the device as discussed in more detail below. In one or more implementations, the user is proximate to the device if the user is detected using biometric recognition techniques, such as fingerprint recognition, iris recognition, facial recognition, voice recognition, grip recognition (how the user holds or grips the device), and so forth. In the case of a wearable device, the user can be proximate to the device if the wearable device is worn by the user, e.g., based on detecting the user's heartbeat via a heartbeat sensor (e.g., based on characteristics distinct to the user such as rhythm, intervals, and/or amplitude). Additionally or alternatively, the user is proximate to the device if the user is within a threshold distance of the device, e.g., based on proximity sensors in the device.

Reference is also made herein to a user being a known user of a device. A known user of a device refers to a user that is registered with or able to log into a device, such as with a password, fingerprint identification, face identification, and so forth. The known user may also be an owner of the device, which refers to a primary user of the computing device. The owner of the device typically is, but need not be, the purchaser of the device (e.g., a parent may pay for a device for their child, and the child may still be referred to as the owner of the device).

The managing device 102 includes various functionality that enables the managing device 102 to perform different aspects of communicating information based on user proximity to a device, as discussed herein. The managing device 102 includes a known user detection system 112, an information presentation system 114, and a communication manager 116. The known user detection system 112 represents functionality (e.g., hardware, software, and/or firmware) for enabling the managing device 102 to detect when a known user of the managing device 102 is proximate to the managing device 102. The information presentation system 114 represents functionality (e.g., hardware, software, and/or firmware) for enabling the managing device 102 to enable or disable presentation of information received from the one or more managed devices 104 and/or indicate to the one or more managed devices 104 to cease or resume sending information to the managing device 102.

The communication manager 116 represents functionality (e.g., hardware, software, and/or firmware) for enabling the managing device 102 to interconnect with other devices and/or networks, such as the one or more networks 110. The communication manager 116, for instance, enables wireless and/or wired connectivity of the managing device 102. For example, the communication manager 116 represents one or more antennas for transmitting and receiving signaling from other devices via the one or more networks 110. Each of the one or more managed devices 104 includes various functionality that enables the managed device 104 to perform different aspects of communicating information based on user proximity to a device, as discussed herein. Each of the one or more managed devices 104 includes an information collection system 118 and a communication manager 120. The information collection system 118 represents functionality (e.g., hardware, software, and/or firmware) for enabling the managed device 104 to collect information regarding the managed device 104 and/or a user of the managed device 104, and to allow or prevent the collected information from being communicated to the managing device 102. The communication manager 120 represents functionality (e.g., hardware, software, and/or firmware) for enabling the managed device 104 to interconnect with other devices and/or networks, such as the one or more networks 110. The communication manager 120, for instance, enables wireless and/or wired connectivity of the managed device 104. For example, the communication manager 120 represents one or more antennas for transmitting and receiving signaling from other devices via the one or more networks 110.

The one or more networks 110 can include computer networks and/or telecommunication networks. For example, the one or more networks 110 can include a wireless local area network (WLAN), a wireless network, a BT network, a cellular network, a satellite network, and/or a fiber optic network. The one or more networks 110 connect one or more devices, such as the managing device 102 and the one or more managed devices 104, among others.

Using the techniques discussed herein, the known user detection system 112 determines whether a known user is proximate to the managing device 102. This determination can be made in any of a variety of manners. In one or more implementations, if a user of the managing device 102 is authenticated by the managing device 102 (e.g., via a password, fingerprint identification, face identification, and so forth), then the user is a known user of the managing device 102. Otherwise, the user is not a known user of the managing device 102. Once the user is determined to be a known user of the managing device 102 the user of the managing device 102 can be determined to be a known user for a threshold amount of time (e.g., 5 or 10 minutes) or until one or more events, also referred to as anomalies, occurs. This allows information to be displayed on a lock screen of the phone, as discussed in more detail below.

In one or more implementations, one or more anomalies may be detected by the known user detection system 112, and in response to detecting one or more such anomalies the known user detection system 112 takes one or more additional measures to authenticate or verify that the user is a known user of the managing device 102, such as using camera and/or audio sensors of the managing device 102 to authenticate the user (e.g., face or fingerprint identification, voice identification, etc.). One anomaly can be at least a threshold number of failed authentication attempts (e.g., wrong password entered) in less than a threshold amount of time (e.g., 5 or more failed authentication attempts in less than 1 minute). Another anomaly can be a location anomaly, where the known user detection system 112 detects irregular movements or location changes of the managing device 102 that deviate from the usual patterns associated with the known user's behavior. For example, if the user typically exits a train at a particular time of day but the location changes of the managing device 102 indicate that the managing device 102 is still on a moving train after that particular time of day, the user may have left the managing device 102 behind on the train.

Another anomaly can be behavioral analysis, where the known user detection system 112 analyzes usage patterns such as typing frequency on the lock screen or application usage after the managing device 102 has been unlocked. For example, if the user is typing twice as fast as normal, or downloading multiple new applications, it may indicate that the managing device 102 is being used by someone other than the user that previously logged into (e.g., unlocked) the managing device 102.

Another anomaly can be geofence configuration. A known user of the managing device 102 can specify (e.g., manually) one or more geofences outside of which the user is asked for extra challenges to prove that the user is a known user of the managing device 102. For example, a known user of the managing device 102 can specify geofences around his or her home and his or her work office so that additional one or more additional measures to authenticate that user is a known user of the managing device 102 are taken when the managing device 102 is outside of those geofences.

While a known user is proximate to the managing device 102, the information presentation system 114 can receive and present (e.g., display, audibly play back) information received from one or more managed devices 104. The information can be presented on the managing device 102 in various different manners, such as in an application or service interface, on a lock screen of the managing device 102, and so forth.

If a known user is not proximate to the managing device 102, the information presentation system 114 communicates an indication to the one or more managed devices 104 to no longer communicate information to the managing device 102. Additionally or alternatively, if a known user is not proximate to the managing device 102, the location information presentation system does not present (e.g., display, audibly play back) information received from a managed device 104.

A managed device 104 can communicate any of a variety of different information regarding the managed device 104 and/or a user 106 of the managed device 104, including personally identifiable information. Examples of such information include the current geographic location of the managed device 104, the managed device 104 exiting or entering a particular geofence, a request by the user 106 to install an application on the managed device 104, a request by the user 106 to access a website, and so forth.

The information regarding the managed device 104 and/or a user 106 of the managed device 104 can be collected by the information collection system 118 in any of a variety of different manners using any of various sensors, transceivers, or other components of the managed device 104. For example, the current geographic location of the managed device 104 can be determined in various manners, such as using a GPS system, using triangulation from signals received from known locations (e.g., Wi-Fi, BT, or BLE signals), and so forth. By way of another example, a location of a geofence can be communicated to the information collection system 118 from various sources, such as the managing device 102 or another device or system.

A managed device 104 can communicate information at any of a variety of regular or irregular intervals (e.g., every 30 seconds, every minute, etc.) or in response to any of various events, such as the managed device 104 exiting or entering a geofence, the geographic location of the managed device 104 changing by at least a threshold amount since the information was last communicated (e.g., changed by at least 200 feet), and so forth.

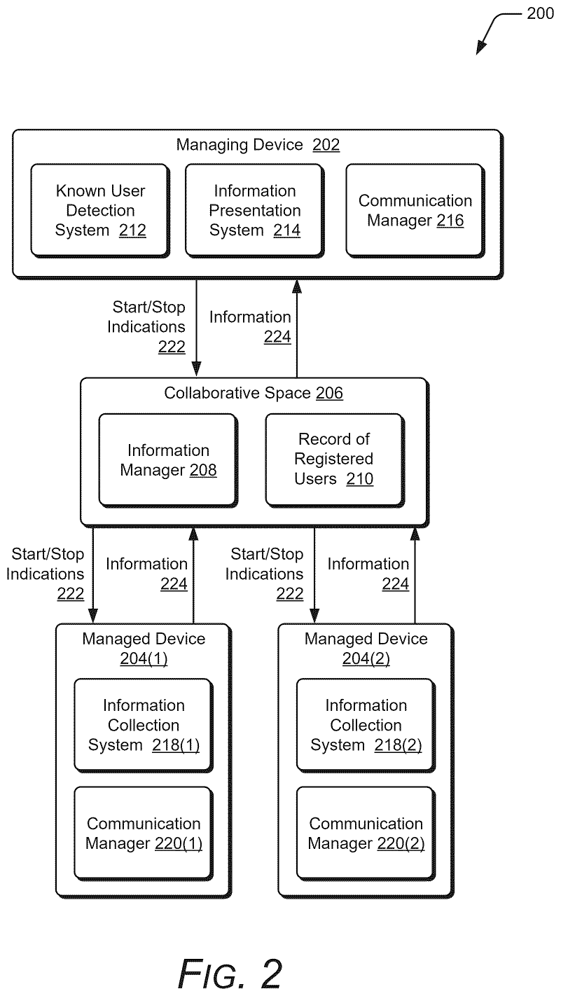

FIG. 2 illustrates an example system 200 for communicating information based on user proximity to a device in accordance with one or more implementations as described herein. The example system 200 may implement aspects of the example system 100 described with reference to FIG. 1. The example system 200 includes a managing device 202, which can be a managing device 102 of FIG. 1, and multiple managed devices 204(1) and 204(2), each of which can be a managed device 104 of FIG. 1. The example system 200 is similar to the example system 100 of FIG. 1 but includes a collaborative space 206. The managing device 202, managed devices 204(1) and 204(2), and/or one or more devices hosting the collaborative space 206 can communicate with one another via one or more networks, such as one or more networks 110 of FIG. 1. The example system 200 is illustrated with two managed devices, however it is to be appreciated that the system 200 can include any number of managed devices.

The collaborative space 206 facilitates communicating information based on user proximity to a device in one or more implementations. For example, the collaborative space 206 can be a database, a server device, and/or any combination of devices that can store data, manipulate data, and/or provide for access of data for one or more devices, such as the managing device 202 and the managed devices 204(1) and 204(2). In one or more implementations, the collaborative space 206 may be an example of a remote database (e.g., cloud or network-based database), a physical database, a web server, an application server, a cloud server, or the like. In some examples, the collaborative space 206 can be hosted or implemented at one or more of the managing devices 202, the managed device 204(1), or the managed device 204(2) as an application, module, and/or local database. The collaborative space 206 includes various functionality that enables a managing device and/or managed device to perform different aspects of the techniques discussed herein, including an information manager 208. The information manager 208 represents functionality (e.g., hardware, software, and/or firmware) implemented by the collaborative space 206 as an external device or internal to the one or more of the managing device 202, the managed device 204(1), or the managed device 204(2) for enabling the collaborative space 206 to communicate (e.g., transmit, send) start and/or stop indications to the managed device 204(1) and/or the managed device 204(2), to receive information from the managed device 204(1) and/or the managed device 204(2), and/or to communicate (e.g., transmit, send) information to the managing device 202 or a component of the managing device 202 (e.g., information presentation system 214).

The managing device 202 as well as the managed devices 204(1) and 204(2) register with the collaborative space 206, which maintains a record of registered users 210, including which users are linked to which other users. For example, the record of registered users 210 includes an indication of which managed devices are linked to (e.g., managed by) which managing devices. The record of registered users 210 allows the collaborative space 206 to route start indications, start indications, and/or information between the managing device 202 and the managed devices 204(1) and 204(2).

The managing device 202 includes a known user detection system 212, an information presentation system 214, and a communication manager 216, analogous to the known user detection system 112, the information presentation system 114, and the communication manager 116 of FIG. 1, respectively. Managed device 204(1) includes an information collection system 218(1) and a communication manager 220(1), analogous to the information collection system 118 and the communication manager 120 of FIG. 1, respectively. Managed device 204(2) includes an information collection system 218(2) and a communication manager 220(2), analogous to the information collection system 118 and the communication manager 120 of FIG. 1, respectively.

The known user detection system 212 determines whether a known user is proximate to the managing device 202. The information presentation system 214 transmits a start or stop indication 222 to the collaborative space 206 based on whether a known user is proximate to the managing device 202 (a start indication if a known user is proximate to the managing device 202 or a stop indication if a known user is not proximate to the managing device 202). The information manager 208 transmits the start or stop indication 222 to the managed devices 204(1) and 204(2).

In response to a start indication, the information collection systems 218(1) and 218(2) collect information regarding the managed devices 204(1) and 204(2), respectively, and/or information regarding the user of the managed devices 204(1) and 204(2), respectively. The information collection systems 218(1) and 218(2) communicates this information 224 to the collaborative space 206, and the information manager 208 communicates this information 224 to the managing device 202. The information presentation system 214 displays or otherwise presents (e.g., plays back audibly) this information 224 at the managing device 202.

In response to a stop indication, the information collection systems 218(1) and 218(2) cease communicating any information 224 to the collaborative space 206, so there is no information 224 for the information manager 208 to communicate to the managing device 202. Additionally or alternatively, the information collection systems 218(1) and 218(2) can cease collecting information regarding the managed devices 204(1) and 204(2), respectively, and/or information regarding the user of the managed devices 204(1) and 204(2), respectively.

Additionally, if the information presentation system 214 determines to transmit a stop indication, the information presentation system 214 disables or ceases presenting (e.g., displaying or playing back audibly) any information 224 that is received. Situations can arise in which the information presentation system 214 receives information 224 before the stop indication can be processed by the collaborative space 206 and/or managed devices 204(1) and 204(2). Disabling or ceasing presenting of any information 224 prevents any received information 224 from being presented at the managing device 202 in such situations.

In one or more implementations, if the information presentation system 214 determines to transmit a stop indication, the information presentation system 214 also deletes or otherwise makes inaccessible (e.g., encrypts) any previously received information 224. Accordingly, such information would not be available for display at the managing device 202 if a known user is not proximate to the managing device 202. This prevents, for example, a thief or other unauthorized user of the managing device 202 from accessing sensitive information such as the location history of the user of the managed device, communication logs with the managed device, and other personal details of the user of the managed device, posing a severe risk to the security of the user of the managed device.

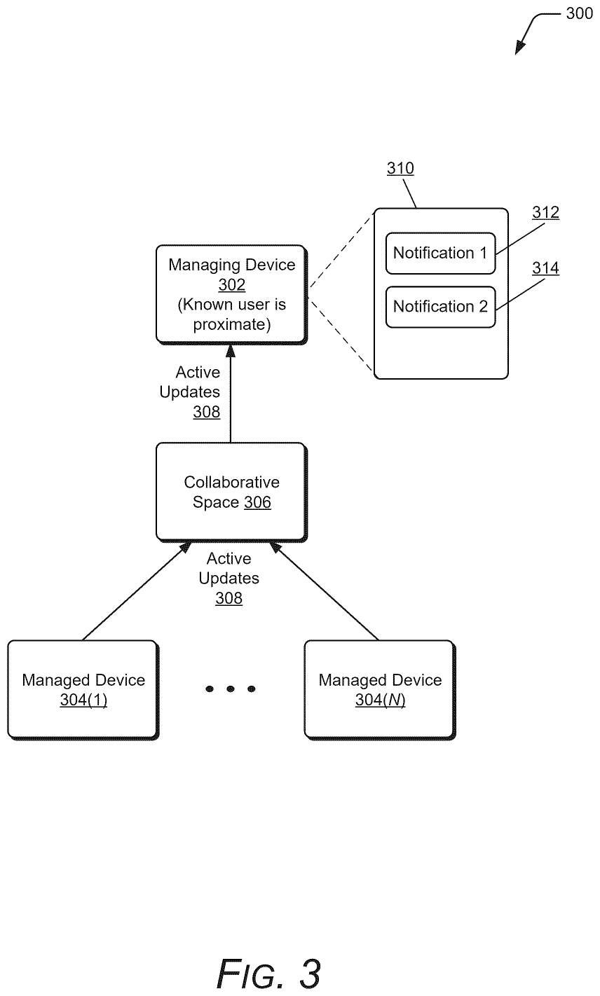

FIG. 3 illustrates an example 300 of operation of the techniques discussed herein. The example 300 includes a managing device 302, which can be a managing device 102 of FIG. 1 or a managing device 202 of FIG. 2, multiple (N) managed devices 304(1), . . . , 304(N) each of which can be a managed device 104 of FIG. 1 or a managed device 204(1) or 204(2) of FIG. 2, and a collaborative space 306, which can be a collaborative space 206 of FIG. 2.

In the example 300, a known user has been determined to be proximate to the managing device 302. Accordingly, the managed devices 304(1), . . . , 304(N) communicate (e.g., transmit or send) active updates 308 to the collaborative space 306, which communicates (e.g., transmits or sends) the active updates 308 to the managing device 302. These active updates 308 are updates to or changes in the information collected by the managed devices 304(1), . . . , 304(N). The managing device 302 displays a graphical user interface (GUI) 310 that includes the information in the active updates 308 as notification 312 and notification 314.

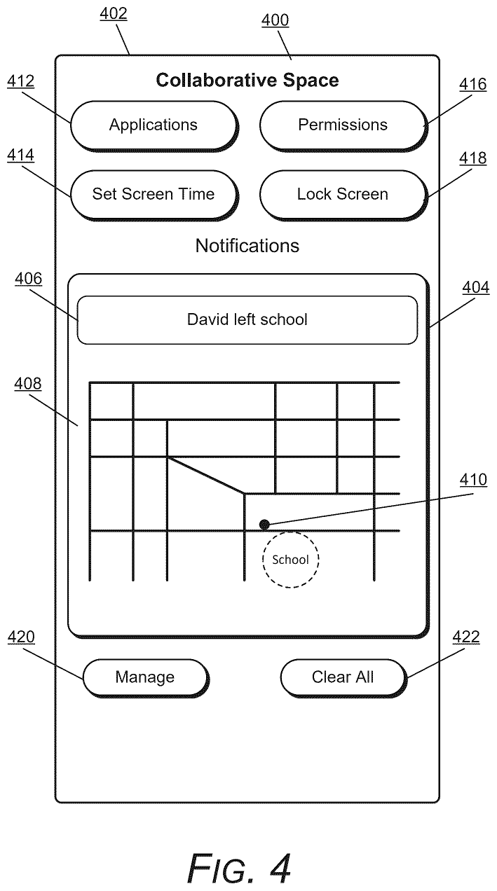

FIG. 4 illustrates an example GUI 400, which supports the techniques discussed herein. The example GUI 400 is displayed by a managing device 402, such as managing device 102 of FIG. 1 or managing device 202 of FIG. 2. In the example GUI 400, the managing device 402 displays a notification 404 for a user of the managing device 402 to view in the collaborative space, such as collaborative space 206 of FIG. 2. The managing device 402 can optionally alert the user of the notification 404, such as by an audio alert, a visual alert, a haptic alert, or any other type of alert. In the example GUI 400, the notification 404 includes a banner 406 and a map 408 that display information received from the managed device. For example, the information received from the managed device may include a current geographic location of the managed device an indication that the managed device has exited a geofence. The banner 406 is a text notification that the user of the managed device (David) has exited the geofence (school), and the map 408 indicates a location of the geofence as well as the current geographic location 410 of the managed device.

The GUI 400 also displays additional user-selectable buttons to perform various actions on the managing device 402. An applications button 412 is selectable by a user of the managing device 402 to control which applications a user of a managed device has access to on the managed device. A set screen time button 414 is selectable by a user of the managing device 402 to control how much time a user of a managed device can spend using the managed device within a given time range (e.g., per day). A permissions button 416 is selectable by a user of the managing device 402 to control what access a user of a managed device has to the managed device (e.g., applications, websites, other functionality of the managed device). A lock screen button 418 is selectable by a user of the managing device 402 to lock the managing device 402.

A manage button 420 is selectable by a user of the managing device 402 to manage various aspects of one or more managed devices, such as adding managed devices that the managing device 402 can receive information from, deleting managed devices that the managing device 402 can receive information from, and so forth. A clear all button 422 is selectable by a user of the managing device 402 to clear or delete all notifications that are displayed by the GUI 400 or that have been received by the managing device 402.

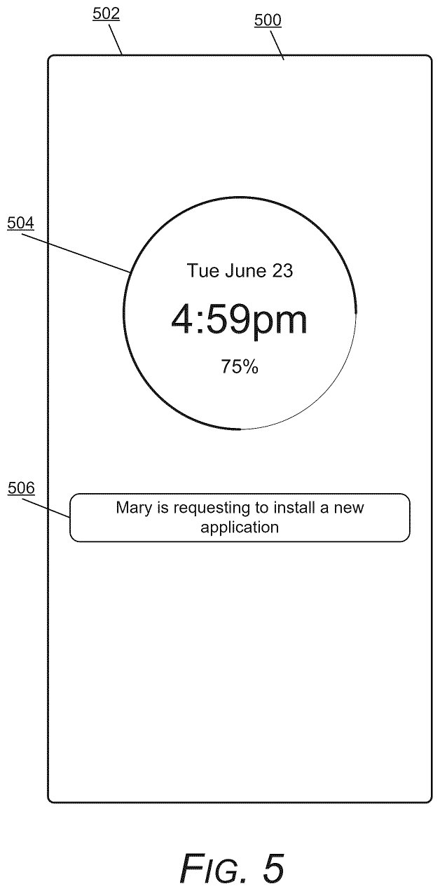

FIG. 5 illustrates an example GUI 500, which supports the techniques discussed herein. The example GUI 500 is displayed by a managing device 502, such as managing device 102 of FIG. 1 or managing device 202 of FIG. 2. In the example GUI 500, the managing device 502 is locked and a user of the managing device 502 is authenticated (e.g., using a passcode, a password, a fingerprint, a face or iris scan, and so forth) to be a known user before the managing device 502 is unlocked. Accordingly, the GUI 500 may also be referred to as a lock screen.

The GUI 500 displays basic information 504, such as a current day, date, time, and indication of how much battery life remains in the managing device 502 (illustrated by the partially completed circle and the value 75%). The GUI 500 also displays a notification 506 for a user of the managing device 502 to on the lock screen. The managing device 502 can optionally alert the user of the notification 506, such as by an audio alert, a visual alert, a haptic alert, or any other type of alert. In the example GUI 500, the notification 506 is a banner that displays information received from the managed device. For example, the information received from the managed device may include an indication that a user of the managed device is requesting to install a new application. The notification 506 is a text notification that the user of the managed device (Mary) is requesting to install a new application on the managed device. In response to the notification 506, a known user of the managing device 502 can unlock or log into the managing device 502 and, such as via a collaborative space, give the user of the managed device permission to install the new application or decline the request.

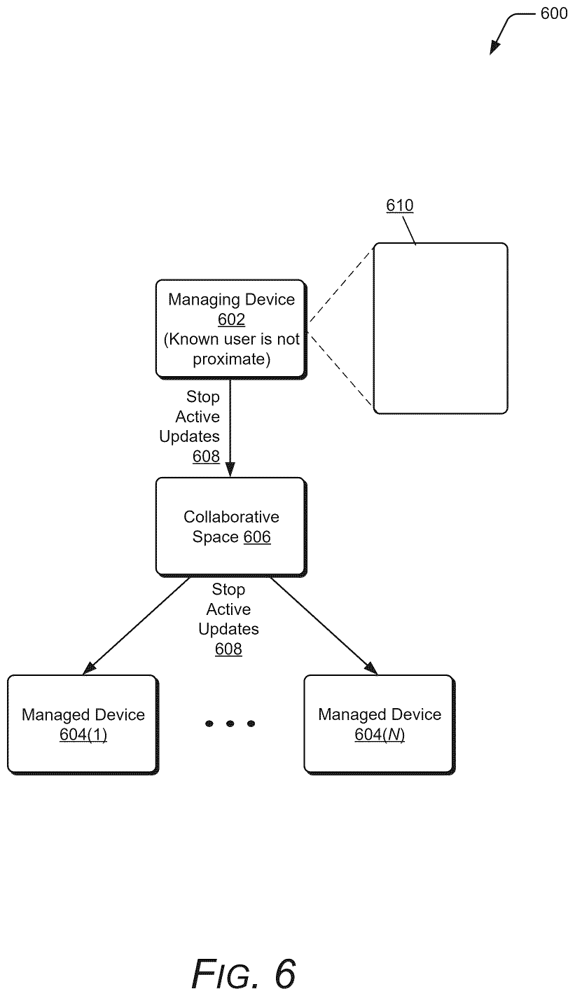

FIG. 6 illustrates an example 600 of operation of the techniques discussed herein. The example 600 includes a managing device 602, which can be a managing device 102 of FIG. 1 or a managing device 202 of FIG. 2, multiple (N) managed devices 604(1), . . . , 604(N) each of which can be a managed device 104 of FIG. 1 or a managed device 204(1) or 204(2) of FIG. 2, and a collaborative space 606, which can be a collaborative space 206 of FIG. 2.

In the example 600, a known user has not been determined to be proximate to the managing device 602. Accordingly, the managing device 602 communicates (e.g., transmits or sends) a stop active updates indication 608 to the collaborative space 606, which communicates (e.g., transmits or sends) the stop active updates indication 608 to the managed devices 604(1), . . . , 604(N). In response to the stop active updates indication 608, the managed devices 604(1), . . . , 604(N) cease communicating any active updates (e.g., updates to or changes in the information collected by the managed devices 604(1), . . . , 604(N)) to the collaborative space 606. The managing device 602 displays a graphical user interface (GUI) 610 but the GUI 610 includes no information received from the managed devices 604(1), . . . , 604(N).

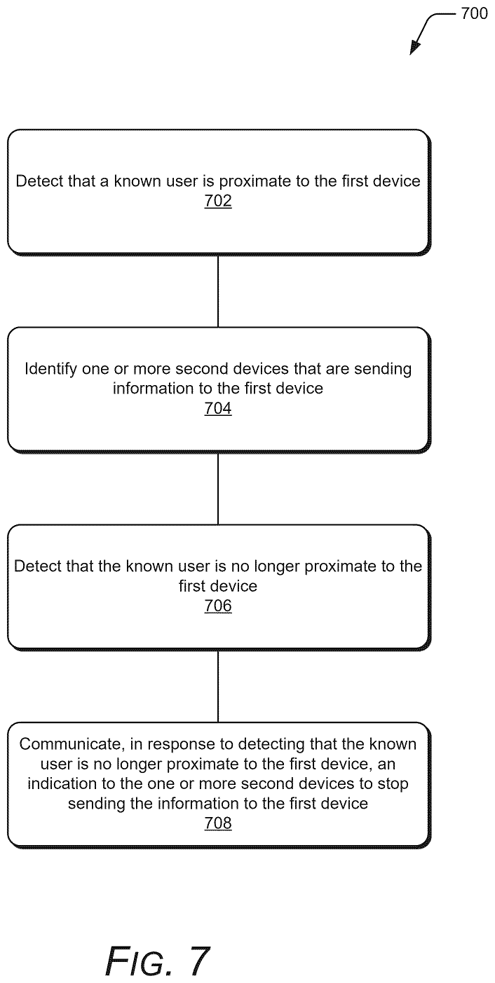

FIG. 7 illustrates an example process 700 for implementing the techniques discussed herein in accordance with one or more embodiments. Process 700 is carried out by a device, such as a managing device of any of FIGS. 1 through 6, and can be implemented in software, firmware, hardware, or combinations thereof. Process 700 is shown as a set of acts and is not limited to the order shown for performing the operations of the various acts.

In process 700, a known user being proximate to a first device is detected (act 702). The first device is, for example, a managing device of any of FIGS. 1 through 6. The user is proximate to the first device if, for example, biometric recognition techniques identify the user, the first device is being worn by the user, the user is within a threshold distance of the first device, and so forth. The user is a known user if the user is registered with or able to log into the first device, such as with a password, fingerprint identification, face identification, and so forth.

One or more second devices that are sending information to the first device are identified (act 704). These one or more second devices can be one or more managed devices of any of FIGS. 1 through 6. These one or more second devices are, for example, linked to the first device via a collaboration space. The information can be personally identifiable information, such as a geographic location of the one or more second devices.

The known user no longer being proximate to the first device is detected (act 706). The user is no longer proximate to the first device if, for example, biometric recognition techniques do not identify the user, the first device is not being worn by the user, the user is not within a threshold distance of the first device, and so forth.

In response to detecting that the known user is no longer proximate to the first device, an indication is communicated to the one or more second devices to stop sending the information to the first device (act 708). Accordingly, the first device no longer receives information, such as personally identifiable information, from the one or more second devices.

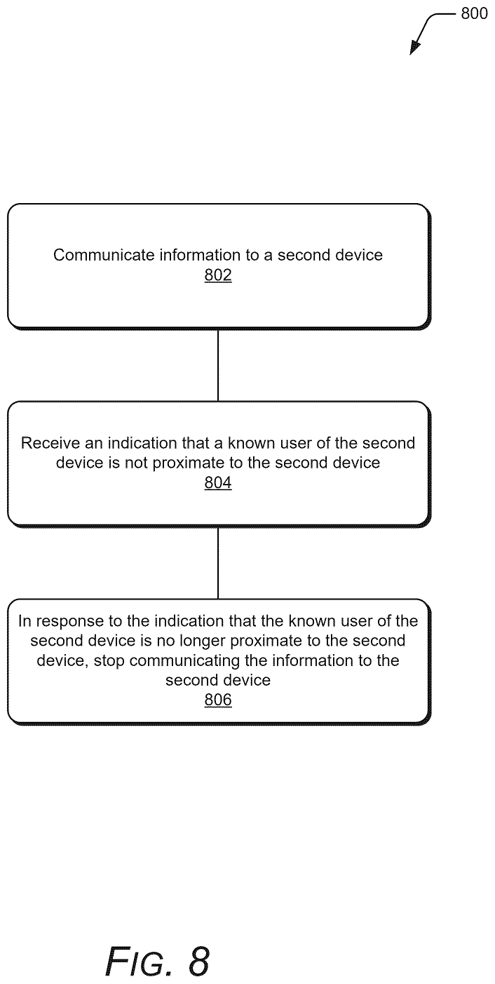

FIG. 8 illustrates an example process 800 for implementing the techniques discussed herein in accordance with one or more embodiments. Process 800 is carried out by a device, such as a managed device of any of FIGS. 1 through 6, and can be implemented in software, firmware, hardware, or combinations thereof. Process 800 is shown as a set of acts and is not limited to the order shown for performing the operations of the various acts.

In process 800, information is communicated to a second device (act 802). The second device is, for example, a managing device of any of FIGS. 1 through 6. The information can be personally identifiable information, such as a geographic location of the device implementing the process 800.

An indication that a known user of the second device is not proximate to the second device is received (act 804). This indication can be sent by the second device and received via a collaborative space. The user of the second device is proximate to the second device if, for example, biometric recognition techniques identify the user, the second device is being worn by the user, the user is within a threshold distance of the second device, and so forth. The user is a known user if the user is registered with or able to log into the second device, such as with a password, fingerprint identification, face identification, and so forth.

In response to the indication that the known user of the second device is no longer proximate to the second device, communicating the information to the second device is stopped (act 806). Accordingly, the second device no longer receives information, such as personally identifiable information, from the device implementing the process 800.

FIG. 9 illustrates various components of an example electronic device that can implement embodiments of the techniques discussed herein. The electronic device 900 can be implemented as any of the devices described with reference to the previous FIG.s, such as any type of client device, mobile phone, tablet, computing, communication, entertainment, gaming, media playback, or other type of electronic device. For example, the managing devices or managed devices as shown and described with reference to FIGS. 1-8 may be implemented as the example device 900.

The electronic device 900 includes one or more data input components 902 via which any type of data, media content, or inputs can be received such as user-selectable inputs, messages, music, television content, recorded video content, and any other type of text, audio, video, or image data received from any content or data source. The data input components 902 may include various data input ports such as universal serial bus ports, coaxial cable ports, and other serial or parallel connectors (including internal connectors) for flash memory, DVDs, compact discs, and the like. These data input ports may be used to couple the electronic device to components, peripherals, or accessories such as keyboards, microphones, or cameras. The data input components 902 may also include various other input components such as microphones, touch sensors, touchscreens, keyboards, and so forth.

The device 900 includes communication transceivers 904 that enable one or both of wired and wireless communication of device data with other devices. The device data can include any type of text, audio, video, image data, or combinations thereof. Example transceivers include wireless personal area network (WPAN) radios compliant with various IEEE 802.15 (Bluetooth™) standards, wireless local area network (WLAN) radios compliant with any of the various IEEE 802.11 (WiFi™) standards, wireless wide area network (WWAN) radios for cellular phone communication, wireless metropolitan area network (WMAN) radios compliant with various IEEE 802.15 (WiMAX™) standards, wired local area network (LAN) Ethernet transceivers for network data communication, and cellular networks (e.g., third generation networks, fourth generation networks such as LTE networks, or fifth generation networks).

The device 900 includes a processing system 906 of one or more processors (e.g., any of microprocessors, controllers, and the like) or a processor and memory system implemented as a system-on-chip (SoC) that processes computer-executable instructions. The processing system 906 may be implemented at least partially in hardware, which can include components of an integrated circuit or on-chip system, an application-specific integrated circuit (ASIC), a field-programmable gate array (FPGA), a complex programmable logic device (CPLD), and other implementations in silicon or other hardware.

Alternately or in addition, the device can be implemented with any one or combination of software, hardware, firmware, or fixed logic circuitry that is implemented in connection with processing and control circuits, which are generally identified at 908. The device 900 may further include any type of a system bus or other data and command transfer system that couples the various components within the device. A system bus can include any one or combination of different bus structures and architectures, as well as control and data lines.

The device 900 also includes computer-readable storage memory devices 910 that enable one or both of data and instruction storage thereon, such as data storage devices that can be accessed by a computing device, and that provide persistent storage of data and executable instructions (e.g., software applications, programs, functions, and the like). Examples of the computer-readable storage memory devices 910 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 900 may also include a mass storage media device.

The computer-readable storage memory device 910 provides data storage mechanisms to store the device data 912, other types of information or data, and various device applications 914 (e.g., software applications). For example, an operating system 916 can be maintained as software instructions with a memory device and executed by the processing system 906 to cause the processing system 906 to perform various acts. The device applications 914 may also include a device manager, such as any form of a control application, software application, signal-processing and control module, code that is native to a particular device, a hardware abstraction layer for a particular device, and so on.

The device 900 can also include one or more device sensors 918, such as any one or more of an ambient light sensor, a proximity sensor, a touch sensor, an infrared (IR) sensor, an accelerometer, a gyroscope, a thermal sensor, an audio sensor (e.g., microphone), a heartbeat sensor, and the like. The device 900 can also include one or more power sources 920, such as when the device 900 is implemented as a mobile device. The power sources 920 may include a charging or power system, and can be implemented as a flexible strip battery, a rechargeable battery, a charged super-capacitor, or any other type of active or passive power source.

The device 900 additionally includes an audio or video processing system 922 that generates one or both of audio data for an audio system 924 and display data for a display system 926. In accordance with some embodiments, the audio/video processing system 922 is configured to receive call audio data from the transceiver 904 and communicate the call audio data to the audio system 924 for playback at the device 900. The audio system or the display system may include any devices that process, display, or otherwise render audio, video, display, or image data. Display data and audio signals can be communicated to an audio component or to a display component, respectively, via an RF (radio frequency) link, S-video link, HDMI (high-definition multimedia interface), composite video link, component video link, DVI (digital video interface), analog audio connection, or other similar communication link. In implementations, the audio system or the display system are integrated components of the example device. Alternatively, the audio system or the display system are external, peripheral components to the example device.

In this example, the device 900 includes a facilitation system 928 that implements various aspects of the described features and techniques described herein. The facilitation system 928 can be implemented with hardware components and/or in software as one of the device applications 914. Examples of the facilitation system 928 are a known user detection system 112 or known user detection system 212, an information presentation system 114 or information presentation system 214, or an information collection system 118 or information collection system 218(1) or 218(2) as discussed above in FIGS. 1 to 8, such as a software application and/or as hardware components in the device. In implementations, the facilitation system 928 may include independent processing, memory, and logic components as a computing and/or electronic device integrated with the example device 900.

Although implementations of techniques for communicating information based on user proximity to a device have been described in language specific to features or methods, the subject of the appended claims is not necessarily limited to the specific features or methods described. Rather, the specific features and methods are disclosed as example implementations of techniques for implementing communicating information based on user proximity to a device. Further, various different embodiments are described, and it is to be appreciated that each described embodiment can be implemented independently or in connection with one or more other described embodiments. Additional aspects of the techniques, features, and/or methods discussed herein relate to one or more of the following:

In some aspects, the techniques described herein relate to a first device, including: at least one memory; and at least one processor coupled with the at least one memory and configured to cause the first device to: detect that a known user is proximate to the first device; identify one or more second devices that are sending information to the first device; detect that the known user is no longer proximate to the first device; communicate, in response to detecting that the known user is no longer proximate to the first device, an indication to the one or more second devices to stop sending the information to the first device.

In some aspects, the techniques described herein relate to a first device, wherein the information includes personally identifiable information.

In some aspects, the techniques described herein relate to a first device, wherein the personally identifiable information includes, for each of the one or more second devices, a geographic location of the second device.

In some aspects, the techniques described herein relate to a first device, wherein the at least one processor is further configured to cause the first device to stop, in response to detecting that the known user is no longer proximate to the first device, displaying information received from the one or more second devices.

In some aspects, the techniques described herein relate to a first device, wherein the at least one processor is further configured to cause the first device to delete, in response to detecting that the known user is no longer proximate to the first device, information previously received from the one or more second devices.

In some aspects, the techniques described herein relate to a first device, wherein the at least one processor is further configured to cause the first device to: detect that the known user is again proximate to the first device; and communicate, in response to detecting that the known user is again proximate to the first device, an indication to the one or more second devices to resume sending the information to the first device.

In some aspects, the techniques described herein relate to a first device, wherein the at least one processor is further configured to cause the first device to: detect one or more anomalies at the first device; and authenticate, in response to detecting the one or more anomalies, a user of the first device to verify that the user of the first device is the known user.

In some aspects, the techniques described herein relate to a first device, wherein the one or more anomalies include at least one of a threshold number of failed authentication attempts in less than a threshold amount of time, irregular movements or location changes of the first device, irregular usage patterns of the first device, or a location of the first device being outside of one or more geofences.

In some aspects, the techniques described herein relate to a first device, including: at least one memory; and at least one processor coupled with the at least one memory and configured to cause the first device to: communicate information to a second device; receive an indication that a known user of the second device is not proximate to the second device; in response to the indication that the known user of the second device is no longer proximate to the second device, stop communicating the information to the second device.

In some aspects, the techniques described herein relate to a first device, wherein the information includes personally identifiable information.

In some aspects, the techniques described herein relate to a first device, wherein the personally identifiable information includes a geographic location of the first device.

In some aspects, the techniques described herein relate to a first device, wherein the at least one processor is further configured to cause the first device to: receive an indication that the known user is again proximate to the second device; and resume, in response to the indication that the known user is again proximate to the second device, communicating information to the second device.

In some aspects, the techniques described herein relate to a method at a first device, including: detecting that a known user is proximate to the first device; identifying one or more second devices that are sending information to the first device; detecting that the known user is no longer proximate to the first device; and communicating, in response to detecting that the known user is no longer proximate to the first device, an indication to the one or more second devices to stop sending the information to the first device.

In some aspects, the techniques described herein relate to a method, wherein the information includes personally identifiable information.

In some aspects, the techniques described herein relate to a method, wherein the personally identifiable information includes, for each of the one or more second devices, a geographic location of the second device.

In some aspects, the techniques described herein relate to a method, further including stopping, in response to detecting that the known user is no longer proximate to the first device, displaying information received from the one or more second devices.

In some aspects, the techniques described herein relate to a method, further including deleting, in response to detecting that the known user is no longer proximate to the first device, information previously received from the one or more second devices.

In some aspects, the techniques described herein relate to a method, further including: detecting that the known user is again proximate to the first device; and communicating, in response to detecting that the known user is again proximate to the first device, an indication to the one or more second devices to resume sending the information to the first device.

In some aspects, the techniques described herein relate to a method, further including: detecting one or more anomalies at the first device; and authenticating, in response to detecting the one or more anomalies, a user of the first device to verify that the user of the first device is the known user.

In some aspects, the techniques described herein relate to a method, wherein the one or more anomalies include at least one of a threshold number of failed authentication attempts in less than a threshold amount of time, irregular movements or location changes of the first device, irregular usage patterns of the first device, or a location of the first device being outside of one or more geofences.

What is claimed is:

1. A first device, comprising:
at least one memory; and
at least one processor coupled with the at least one memory and configured to cause the first device to:
detect that a known user is proximate to the first device;
identify one or more second devices that are sending information to the first device;
detect that the known user is no longer proximate to the first device;
communicate, in response to detecting that the known user is no longer proximate to the first device, an indication to the one or more second devices to stop sending the information to the first device.

2. The first device of claim 1, wherein the information comprises personally identifiable information.

3. The first device of claim 2, wherein the personally identifiable information comprises, for each of the one or more second devices, a geographic location of the second device.

4. The first device of claim 1, wherein the at least one processor is further configured to cause the first device to stop, in response to detecting that the known user is no longer proximate to the first device, displaying information received from the one or more second devices.

5. The first device of claim 1, wherein the at least one processor is further configured to cause the first device to delete, in response to detecting that the known user is no longer proximate to the first device, information previously received from the one or more second devices.

6. The first device of claim 1, wherein the at least one processor is further configured to cause the first device to:
detect that the known user is again proximate to the first device; and
communicate, in response to detecting that the known user is again proximate to the first device, an indication to the one or more second devices to resume sending the information to the first device.

7. The first device of claim 1, wherein the at least one processor is further configured to cause the first device to:
detect one or more anomalies at the first device; and
authenticate, in response to detecting the one or more anomalies, a user of the first device to verify that the user of the first device is the known user.

8. The first device of claim 7, wherein the one or more anomalies include at least one of a threshold number of failed authentication attempts in less than a threshold amount of time, irregular movements or location changes of the first device, irregular usage patterns of the first device, or a location of the first device being outside of one or more geofences.

9. A first device, comprising:
at least one memory; and
at least one processor coupled with the at least one memory and configured to cause the first device to:
communicate information to a second device;
receive an indication that a known user of the second device is not proximate to the second device;
in response to the indication that the known user of the second device is no longer proximate to the second device, stop communicating the information to the second device.

10. The first device of claim 9, wherein the information comprises personally identifiable information.

11. The first device of claim 10, wherein the personally identifiable information comprises a geographic location of the first device.

12. The first device of claim 9, wherein the at least one processor is further configured to cause the first device to:
receive an indication that the known user is again proximate to the second device; and
resume, in response to the indication that the known user is again proximate to the second device, communicating information to the second device.

13. A method at a first device, comprising:
detecting that a known user is proximate to the first device;
identifying one or more second devices that are sending information to the first device;
detecting that the known user is no longer proximate to the first device; and
communicating, in response to detecting that the known user is no longer proximate to the first device, an indication to the one or more second devices to stop sending the information to the first device.

14. The method of claim 13, wherein the information comprises personally identifiable information.

15. The method of claim 14, wherein the personally identifiable information comprises, for each of the one or more second devices, a geographic location of the second device.

16. The method of claim 13, further comprising stopping, in response to detecting that the known user is no longer proximate to the first device, displaying information received from the one or more second devices.

17. The method of claim 13, further comprising deleting, in response to detecting that the known user is no longer proximate to the first device, information previously received from the one or more second devices.

18. The method of claim 13, further comprising:
detecting that the known user is again proximate to the first device; and
communicating, in response to detecting that the known user is again proximate to the first device, an indication to the one or more second devices to resume sending the information to the first device.

19. The method of claim 13, further comprising:
detecting one or more anomalies at the first device; and
authenticating, in response to detecting the one or more anomalies, a user of the first device to verify that the user of the first device is the known user.

20. The method of claim 19, wherein the one or more anomalies include at least one of a threshold number of failed authentication attempts in less than a threshold amount of time, irregular movements or location changes of the first device, irregular usage patterns of the first device, or a location of the first device being outside of one or more geofences.
